(19) United States
(12) Patent Application Publication
(10) Pub. No.: US 2018/0361509 A1
(43) Pub. Date: Dec. 20, 2018

(54) Powder-Bed-Based Additive Manufacturing Method With Surface Post-Treatment

(71) Applicant: Siemens Aktiengesellschaft, Muenchen (DE)

(72) Inventor: Daniel Reznik, Berlin (DE)

(73) Assignee: Siemens Aktiengesellschaft, Muenchen (DE)

(21) Appl. No.: 15/739,812

(22) PCT Filed: Jun. 29, 2016
(86) PCT No.: PCT/EP2016/065158

§ 371 Date: Dec. 26, 2017

(30) Foreign Application Priority Data
Jul. 3, 2015 (DE) 10 2015 212 529.7

(51) Int. Cl. B23K 26/354; B33Y 10/00; B33Y 30/00; B33Y 40/00; C21D 10/00; C21D 1/09; B23K 26/34

(52) U.S. Cl. CPC B23K 26/354; B33Y 10/00; B33Y 30/00; B23K 26/34; C21D 10/005; C21D 1/09; B33Y 40/00

(57) ABSTRACT

The present disclosure relates to powder-bed-based additive manufacturing methods, in which a component is produced layer by layer in a build-up process by local melting of particles in a powder bed. For example, a powder-bed-based additive manufacturing method may include: producing a component layer by layer in a build-up process by local melting of particles in a powder bed; interrupting the build-up process after a layer has been completed; post-treating a surface of the component by laser peening, wherein compressive stresses are generated at the surface of the layer that has been completed; and restarting the build-up process for producing a next layer. An installation for the powder-bed-based additive manufacturing method may include an application apparatus for an ablation medium.

### CROSS-REFERENCE TO RELATED APPLICATIONS

This application is a U.S. National Stage Application of International Application No. PCT/EP2016/065158 filed Jun. 29, 2016, which designates the United States of America, and claims priority to DE Application No. 10 2015 212 529.7 filed Jul. 3, 2015, the contents of which are hereby incorporated by reference in their entirety.

### TECHNICAL FIELD

The present disclosure relates to powder-bed-based additive manufacturing methods, in which a component is produced layer by layer in a build-up process by local melting of particles in a powder bed.

### BACKGROUND

It is known that components which have been completed by laser sintering may form tensile stresses at the surface. This is due to the fact that very small volumes in the powder bed are melted by the laser during selective laser melting (and also during selective electron beam melting). If the laser leaves the current molten pool, the molten region cools down at a cooling rate of approximately 10⁵° C./s, and correspondingly shrinks, this explaining the formation of the tensile stresses. The layers of the component which have previously been produced there beneath are accordingly subjected to compressive stress, since these absorb the tensile stresses at the surface.

Tensile stresses at the surface of components may have a disadvantageous effect in metallic structures, because a corrosive attack or cracks can propagate more rapidly into the interior of the component on account of mechanical loading. In some systems, the component built by laser melting is subjected to a post-treatment, with which the existing tensile stresses at the surface are converted into compressive stresses. This can be effected by a heat treatment (stress-relief annealing), by hot isostatic pressing, or else by machining of the surface, peening. Some systems include shot peening or laser peening.

Laser peening can be effected not only as a post-treatment of a completed component, but also during the production thereof, in that the build-up process is interrupted for use of the laser peening after completion of one layer. Laser peening (also referred to as laser shock peening) is described in detail, for example, in U.S. Pat. No. 5,674,328. A liquid or solid ablation medium is applied to the surface to be treated and is then removed by laser pulses. This operation is also referred to as laser ablation. Since the laser is pulsed, the sudden evaporation of the ablation medium creates a shock wave, which also extends proceeding from the surface into the interior of the component, where it leads to a forging operation. The local deformation of the material generates compressive stresses, as a result of which even tensile stresses can be relieved.

However, a post-treatment by means of laser peening presupposes that the surface of the component is accessible to the laser after production has been effected by the laser melting. However, laser melting and other additive manufacturing methods may be used to produce components which have a very complex geometry. This also gives rise to cavities and inner surfaces which can no longer be reached by a laser after the component has been completed.

### SUMMARY

The teachings of the present disclosure may enable a powder-bed-based additive manufacturing method for a component, with which it is also possible to produce components of complex geometry having surfaces which are subjected to compressive stresses close to the surface, with the intention being to keep the outlay when generating the compressive stresses as low as possible.

For example, a powder-bed-based additive manufacturing method, in which a component (25) is produced layer by layer in a build-up process by local melting of particles in a powder bed (16), and a post-treatment of the surface (27) of the component is carried out by laser peening, wherein compressive stresses are generated in the component (25) at the surface (27), may include: for the post-treatment of the surface (27) of the component (25), the build-up process is interrupted after one layer has been completed, the laser peening is carried out for parts of the surface (27) of the component (25) which have already been formed, and the build-up process for producing the next layer is started again. An application apparatus (26, 31) for an ablation medium is provided in the installation.

In some embodiments, the build-up process is interrupted several times for the post-treatment, and the parts of the surface (27) which have already been formed are subjected to the post-treatment in such a manner that said post-treated parts directly adjoin parts of the surface (27) which have already been post-treated previously.

In some embodiments, the post-treatment is limited to parts of the surface (27) which are no longer accessible for a post-treatment after the component (25) has been completed.

In some embodiments, in each case particles which have not been melted before the post-treatment are removed from that part of the surface (27) which is provided for the post-treatment.

In some embodiments, an ablation medium for the laser peening is bonded on in the form of a film (29).

In some embodiments, an ablation medium for the laser peening is applied as a layer (37).

In some embodiments, the layer (37) is applied by printing.

In some embodiments, after the laser peening has been effected, residues of an ablation medium which has not been consumed during the laser peening are removed from the surface (27) of the component (25), before the build-up process for producing the next layer is started again.

In some embodiments, the non-consumed ablation medium is removed using an energy source (20), which is also used for melting the particles.

As another example, some embodiments may include an installation for a powder-bed-based additive manufacturing method comprising: a powder bed receptacle (12), an energy source, with which a powder bed located in the powder bed receptacle can be locally melted, and in addition to the energy source (20), a pulsed laser, which can be directed at the powder bed receptacle (12) and with which laser peening can be carried out. An application apparatus (26, 31) for an ablation medium is provided in the installation.

In some embodiments, the application apparatus (26, 31) has a print head (26) for a liquid ablation medium.

In some embodiments, the application apparatus has a supply reel (31) for an ablation medium in the form of a film (29).

In some embodiments, the film (29) has the form of a strip.

### BRIEF DESCRIPTION OF THE DRAWINGS

Further details will be described herein below with reference to the drawing. Identical elements of the drawing or corresponding elements of the drawing are provided in each case with the same reference signs, and will be explained repeatedly only if there are differences between the individual figures.

FIGS. 1 and 2 show, schematically in section, exemplary embodiments of the installation according to the teachings of the present disclosure for a powder-bed-based additive manufacturing method, and

FIGS. 3 to 9 schematically show selected steps of an exemplary embodiment of the powder-bed-based additive manufacturing method according to the teachings of the present disclosure.

### DETAILED DESCRIPTION

The teachings of the present disclosure may be embodied in an installation for a powder-bed-based additive manufacturing method. Said installation may include a powder bed receptacle, this being a device in which a powder bed can be produced. For this purpose, a metering device for the powder is provided in the installation, with the powder bed receptacle also having a building platform on which the component to be produced in an additive manner is located and which can be lowered layer by layer. To produce the component, an energy source is also provided in the installation, with which energy source a powder bed located in the powder bed receptacle can be locally melted. The energy source may comprise a laser for producing a laser beam or an electron source for producing an electron beam. It is therefore possible to carry out selective laser melting, selective laser sintering, and/or selective electron beam melting.

For the post-treatment of the surface of the component, the build-up process may be interrupted after one layer has been completed. Then, the laser peening is carried out for parts of the surface of the component which have already been formed, wherein the component remains in the powder bed of the installation for the powder-bed-based additive manufacturing method for said post-treatment. Therefore, the build-up process for producing the next layer can then be started again. It is thus provided that the powder-bed-based additive manufacturing process is interrupted at least once in order to perform a post-treatment by laser peening. This has the advantage that component regions which are no longer accessible after the component has been completed (for example cavities) can also be post-treated by the laser peening. To carry out the laser peening in the manufacturing installation for the additive manufacturing method, said manufacturing installation has to be modified accordingly. A pulsed laser is required for treatment by laser peening. In addition, an ablation medium may be applied to those component regions of the component being produced which are to be post-treated, so an application apparatus is provided in the manufacturing installation.

In some embodiments, a modified installation for a powder-bed-based additive manufacturing method, wherein, in addition to the energy source which is provided for melting of the powder bed, a pulsed laser which can be directed at the powder bed receptacle, and thus can also be directed at parts of a component being produced which have already been completed, is integrated in said installation. Using said pulsed laser, it is then possible to carry out laser peening, wherein, before said treatment, an ablation medium has to be applied by means of an application apparatus to the component regions to be post-treated. The power of the pulsed laser has to be such that it is sufficient for carrying out the laser peening.

The application apparatus for the ablation medium may include a print head for a liquid ablation medium. In this respect, components which are already used in additive manufacturing methods, such as 3D printing, may be used. These may be integrated in the installation for laser melting, and allow for the application of a liquid ablation medium. The latter can be used as a liquid film for laser peening. Another possibility consists in the fact that the liquid ablation medium dries (evaporation of a solvent) or cures before the laser peening is carried out. The liquid ablation medium may also contain solids in the form of particles.

Some embodiments may include an ablation medium in the form of a film. This can be provided by an application apparatus in the form of a reel in the installation. The ablation medium can then simply be unrolled onto the surface of the component being produced. In some embodiments, the film can have the form of a strip. Said strip must be sufficiently wide that either one track of laser pulses or a plurality of tracks of laser pulses alongside one another can be applied thereto. In this case, the ablation medium can advantageously be exploited very effectively, without producing a large amount of waste of the film. In the case of relatively large areas to be treated (that is to say areas that are wider than the strip width), the film strip then has to be unrolled repeatedly and displaced transversely to its longitudinal extent over the area to be treated, in order to produce neighboring tracks of laser pulses on the surface to be treated.

In some embodiments, the build-up process is interrupted several times for the post-treatment, and the parts of the surface which have already been formed are subjected to the post-treatment in such a manner that said post-treated parts directly adjoin parts of the surface which have already been post-treated previously. In this way, an extensive post-treatment of inner surfaces of components is possible. A strategy for the post-treatment can be readily calculated with the knowledge of the CAD model, since this is available anyway for the production of the component by the additive manufacturing method.

In some embodiments, the post-treatment is limited to parts of the surface which are no longer accessible for a post-treatment after the component has been completed. As a result, it is possible to minimize the outlay which arises from the fact that the additive manufacturing method has to be frequently interrupted for the post-treatment taking place in stages. Outer, i.e. accessible, surfaces can also be subjected to a post-treatment in a manner known after the entire component has been completed. In some embodiments, said post-treatment may be carried out, for example, also by laser peening, but also by other methods for post-treatment.

In some embodiments, in each case particles which have not been melted before the post-treatment are removed from that part of the surface which is provided for the post-treatment. By way of example, this can be effected by local suction extraction of the powder particles. The application of the ablation medium to the surfaces which are to be post-treated is then not disturbed by remaining particles. Moreover, it is possible to carry out a post-treatment of parts of the component which have previously been produced in a plurality of successive steps of the additive manufacturing method. This has the advantage that the process for the additive manufacturing of the component has to be interrupted less often. However, the post-treatment of the component regions has to be carried out as long as the inner surfaces of the component which have been produced are still accessible. In other words, the post-treatment has to be effected before the inner surfaces are no longer accessible owing to closure of the component volume.

In some embodiments, an ablation medium for the laser peening can be bonded to the component in the form of a film. In this case, as already explained, it is possible to unroll the film from a reel. Another possibility consists in suitably cutting film pieces to size and applying them directly to the component region which is to be post-treated by means of an application apparatus. As the application apparatus, it is possible to use, for example, handling systems as are common in electronics assembly, in particular suction heads, which temporarily fix the film pieces which have been cut to size by way of a negative pressure and place them on the surface of the component which is to be post-treated.

In some embodiments, after the laser peening has been effected, residues of an ablation medium which has not been consumed during the laser peening are removed from the surface of the component, before the build-up process for producing the next layer is started again. By way of example, this can be effected by suction extraction and has the advantage that subsequent layers of the component cannot be contaminated by the ablation material as they are being produced. In some embodiments, the non-consumed ablation medium is removed using that energy source which is also used for melting the particles. The laser beam or the electron beam can be used to evaporate the ablation material, this energy not being applied in a pulsed manner in order that undesirable laser peening cannot occur. The material is removed continuously.

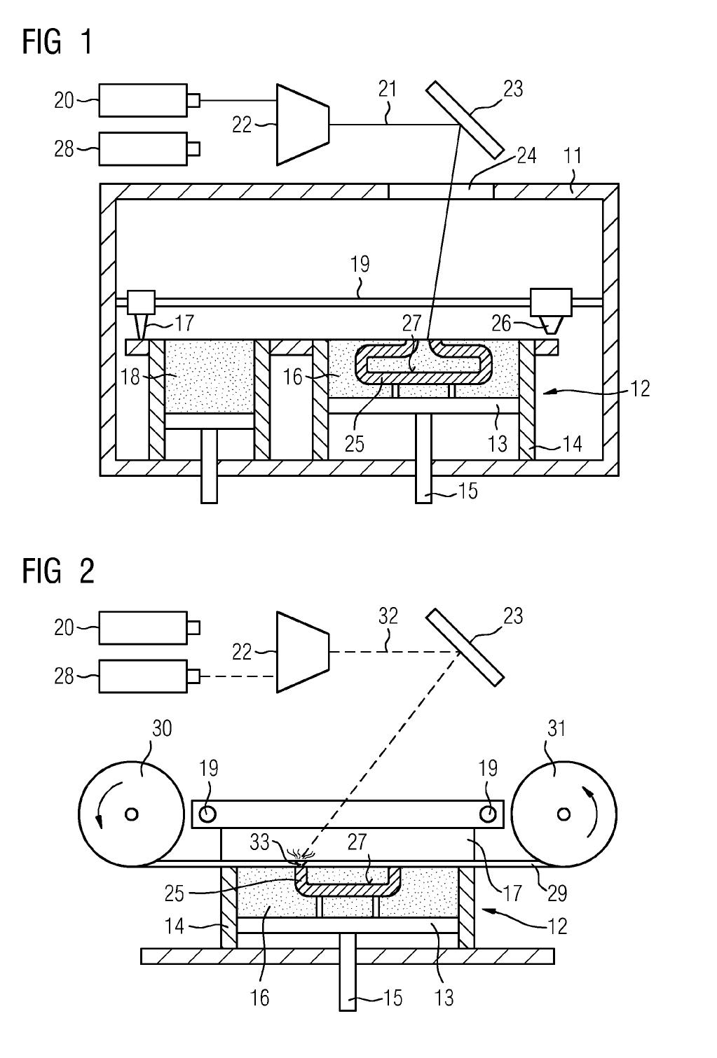

In some embodiments, a manufacturing installation as shown in FIG. 1 has a process chamber 11, in which a powder bed receptacle 12 is provided. The latter has a building platform 13, which is surrounded by a side wall 14 and can be lowered by way of a cylinder 15. This forms a trough-shaped hollow space, in which a powder bed 16 can be produced. To produce the powder bed, a doctor blade 17 is available, and can distribute powder from a powder supply over the powder bed 16. The doctor blade 17 can be moved along a guide rail 19.

FIG. 1 furthermore shows how a laser beam 21 can be generated by means of a laser as an energy source 20. Said laser beam is introduced via an optical coupler 22 and a deflection mirror 23, through a window 24, into the process chamber 11, where it brushes the surface of the powder bed 16 where a component 25 is to be formed. Instead of a laser as an energy source 20, it is also possible to use a device for generating an electron beam (not shown).

A print head 26 can also be moved by way of the guide rail 19 over the surface of the powder bed 16, to provide a liquid ablation medium there for a subsequent treatment of a surface 27 of the component 25. For this purpose, the print head 26 is lowered onto the areas of the component 25 which are to be post-treated, where it applies the liquid ablation medium. A pulsed laser 28 which can be used to carry out the post-treatment is then activated. In this respect, the optical coupler 22 and the deflection mirror 23 are also used (cf. FIG. 2).

FIG. 2 shows another method for applying an ablation medium in the form of a film 29. Said film is unrolled from a supply reel 30 and the remnants of the film 29 are rolled up onto a further reel 31. This is what is termed a reel-to-reel process. FIG. 2 also shows the doctor blade 17, with the direction of movement of the doctor blade 17 via the guide rail 19 being oriented at a right angle to the direction of movement of the film 29 from the supply reel 30 toward the reel 31. The doctor blade 17 and the film 29 can thus be lowered alternately onto the powder bed 16.

The pulsed laser 28 is used to generate a pulsed laser beam 32, which carries out laser peening on an inner surface 27 of the component 25. In the process, the material of the film 29 evaporates at the corresponding point 33, and this leads to the laser peening process which has already been described.

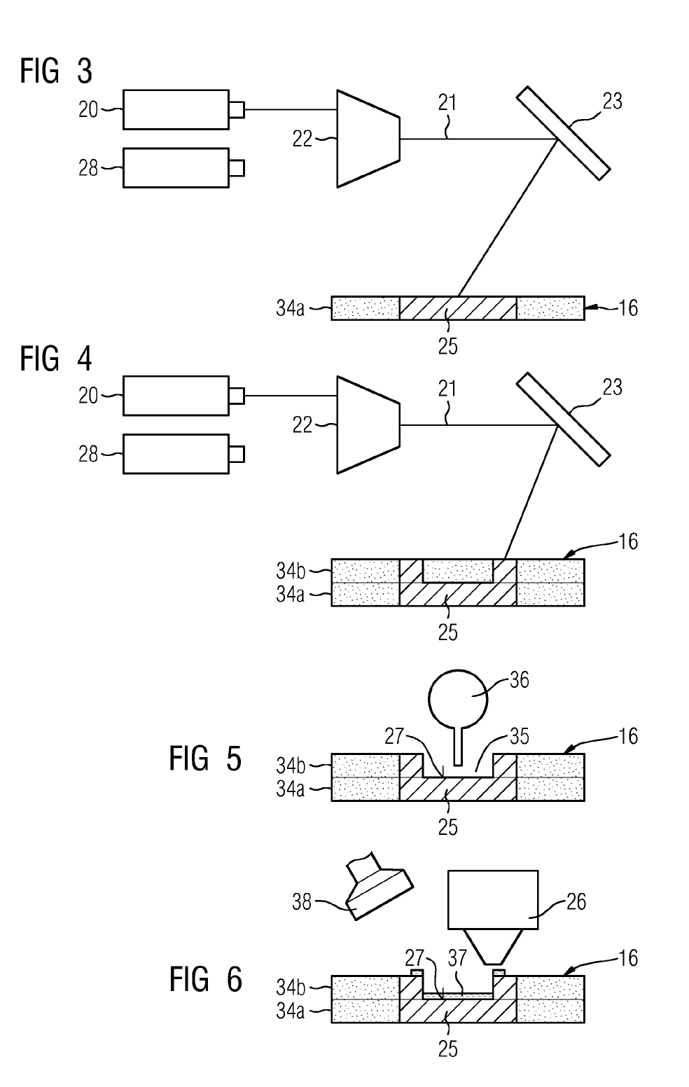

FIGS. 3 to 9 show a possible sequence of an example method by way of example. In this respect, only the components of the manufacturing installation which are required in the manufacturing step in question are shown in each case. The powder bed, too, is shown without its surroundings of a building platform 13 or a side wall 14, it being possible for the structure of the manufacturing installation which is used in FIGS. 3 to 9 to be configured in the way shown in FIG. 1.

FIG. 3 shows how a first layer 34a of the powder bed was produced. The laser beam 21 is used to produce the first layer of a component 25 in said layer 34a. The component which is formed in the first layer 34 is shown in a hatched form.

FIG. 4 shows how a second layer 34b was applied to the powder bed and is then partially melted by means of the laser 21. This forms a further part of the component 25, which will later provide a side wall of the latter.

FIG. 5 shows how the powder of the powder bed is removed by means of a suction extraction apparatus 36 from a recess 35 which has been formed in the component.

FIG. 6 shows how a liquid ablation medium 37 is applied by means of the print head 26 to the surface 27 of the component 25. Said ablation medium 37 can then be cured by means of a radiant heater 38.

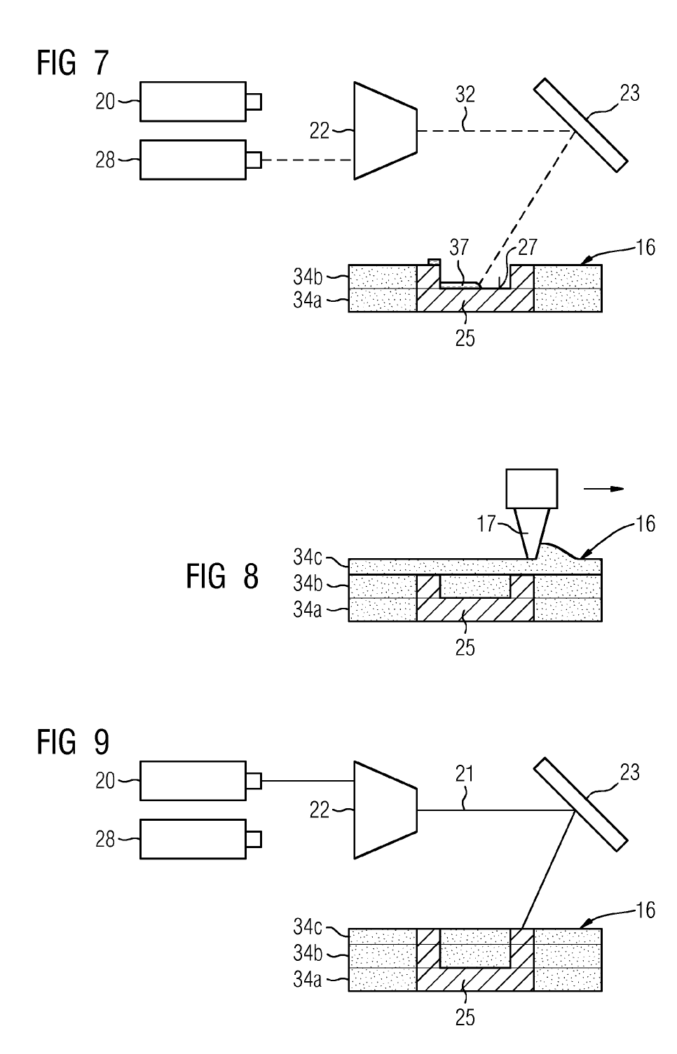

It can be seen in FIG. 7 how a pulsed laser beam 32 is generated by means of the pulsed laser 28 and evaporates the ablation medium 37 on the surface 27. In this process, compressive stresses are formed at the surface 27 in regions where method-related tensile stresses arose previously.

FIG. 8 shows how a third layer 34c is produced in the powder bed by means of the doctor blade 17. In this case, the recess 35 (cf. FIG. 5) is also filled up again.

FIG. 9 shows how the selective laser melting method is started again for the third layer 34c, and the wall of the component 25 which is being formed is continued. By repeating steps 6 and 7, the perpendicular wall which is being formed can be freed of tensile stresses layer by layer, by carrying out laser peening.

What is claimed is:

1. A powder-bed-based additive manufacturing method, the method comprising:
producing a component layer by layer in a build-up process by local melting of particles in a powder bed;
interrupting the build-up process after a layer has been completed;
post-treating a surface of the component by laser peening, wherein compressive stresses are generated at the surface of the layer that has been completed; and
restarting
the build-up process for producing a next layer;
wherein an installation for the powder-bed-based additive manufacturing method includes an application apparatus for an ablation medium.

2. The manufacturing method as claimed in claim 1, further comprising:
interrupting the build-up process several times for the post-treatment at the surface of respective layers; and
subjecting the parts of the surface which have already been formed to the post-treatment in such a manner that said post-treated parts directly adjoin parts of the surface which have already been post-treated previously.

3. The manufacturing method as claimed in claim 1, wherein the post-treatment is limited to parts of the surface which will be no longer accessible for post-treatment after the component has been completed.

4. The manufacturing method as claimed in claim 1, wherein in each case particles which have not been melted before the post-treatment are removed from that part of the surface provided for the post-treatment.

5. The manufacturing method as claimed in claim 1, wherein an ablation medium for the laser peening is bonded on in the form of a film.

6. The manufacturing method as claimed in claim 1, further comprising applying an ablation medium for the laser peening as a layer.

7. The manufacturing method as claimed in claim 6, further comprising applying the layer by printing.

8. The manufacturing method as claimed in claim 1, further comprising, after the laser peening has been effected, removing residues of an ablation medium which has not been consumed during the laser peening from the surface of the component, before the build-up process for producing the next layer is started again.

9. The manufacturing method as claimed in claim 8, further comprising removing the non-consumed ablation medium using an energy source, which is also used for melting the particles.

10. An installation for a powder-bed-based additive manufacturing method, the installation comprising:
a powder bed receptacle;
an energy source, with which a powder bed located in the powder bed receptacle can be locally melted; and
a pulsed laser directed at the powder bed receptacle to complete laser peening; and
an application apparatus for an ablation medium.

11. The installation as claimed in claim 10, wherein the application apparatus has a print head for a liquid ablation medium.

12. The installation as claimed in claim 10, wherein the application apparatus includes a supply reel for an ablation medium in the form of a film.

13. The installation as claimed in claim 12, wherein the film comprises a strip.
